(19) United States
(12) Patent Application Publication
(10) Pub. No.: US 2015/0026823 A1
(43) Pub. Date: Jan. 22, 2015

(54) METHOD AND SYSTEM FOR ENTITLEMENT SETTING, MAPPING, AND MONITORING IN BIG DATA STORES

(71) Applicant: Dataguise, Inc., Fremont, CA (US)

(72) Inventors: Subramanian Ramesh, San Jose, CA (US); Jaspaul Singh Chahal, Fremont, CA (US); Hemant Diman, Fremont, CA (US)

(73) Assignee: DATAGUISE, INC.

(21) Appl. No.: 14/218,945

(22) Filed: Mar. 18, 2014

Related U.S. Application Data
(60) Provisional application No. 61/794,680, filed on Mar. 15, 2013.

(51) Int. Cl. G06F 21/62

(52) U.S. Cl. CPC G06F 21/6218; G06F 21/6245
USPC 726/28

(57) ABSTRACT

A method and system for securing sensitive data content in big data stores is provided. In an example method, entities within the big data store that contain sensitive data are identified. Then, users who have entitlement to access these sensitive entities are identified, along with their level of entitlement. Access controls are then set, based on which users can operate on the sensitive entities. Access or attempts to access these entities is monitored on an ongoing basis. An example system maps entitlement to entities within the big data store that contain sensitive content, to monitor access to these entities and to set access controls for users accessing the big data store.

### RELATED APPLICATIONS

This application claims the benefit of priority to U.S. Provisional Patent Application No. 61/794,680 filed Mar. 15, 2013, and incorporated by reference herein in its entirety.

### FIELD OF THE INVENTION

This invention is generally related to the use of information about the location of sensitive data in a big data store to intelligently view and set user entitlements to entities containing that data. It is also related to monitoring access to the entities containing the sensitive data on an ongoing basis.

### BACKGROUND OF THE INVENTION

As the amount of data being captured and analyzed by enterprises across the globe increases exponentially, new technologies have emerged to manage the quantum of data. The new data is orders of magnitude larger than the data previously managed by enterprises in traditional relational databases and standard non-distributed file systems. This patent application refers to these stores as “big data stores”. There are a variety of systems, ranging from Hadoop® and distributed key-value stores such as HBase, to NoSQL systems such as Couchbase® and MongoDB® that implement the ability to store big data, typically using highly parallel storage mechanisms on commodity hardware.

Big data stores are often used to store data collected from the web, such as Twitter® feeds and Facebook® conversations, call records from call centers and telephones, transaction data for financial institutions, and weather data. Big data stores generally house a wide variety of information, and are accessed by a variety of end users within corporations. As a result, discovery, identification, protection of sensitive data, and control and monitoring of access to the data within big data store are of utmost importance for an enterprise.

The sensitive data referred to above may include one or more of, but is not limited to, bank account numbers, passwords, case histories, and personal/professional communication data such as instant message and email data, bank transaction data, and security codes. The sensitive data is valuable, and therefore should be appropriately protected. Enterprises employ various techniques to protect the sensitive data from being exposed. In order to secure a piece of sensitive data, it is critical to correctly identify such data in a data store. Existing techniques identify sensitive data based on one or more of, but not limited to, predefined users, predefined data types, or predefined data owners, and predefined state of the data. The existing techniques address data in databases, traditional file systems, and similar data stores that have limited parallel processing capabilities, and limited storage capacities compared with the new highly distributed file systems such as Hadoop® Distributed File Systems. The existing techniques do not take advantage of the parallel processing provided by the new systems, and therefore will not scale to the data sizes supported by the new DFSs. New scalable techniques have been developed to identify sensitive data in big data stores. For example, one of the discovery techniques as described in U.S. patent application Ser. No. 13/834,947, “Method and System for Masking Sensitive Data in a Distributed File System,” which is incorporated by reference herein in its entirety, could be used for identifying sensitive data.

Having identified where the sensitive data resides, it is also important to know and control who has access to it, who is attempting to access it, and when the data was modified. It is also important to either mask or encrypt the data if the business use case requires it. Existing techniques do not handle these requirements for big data stores. Existing techniques also do not handle all these in a unified way that takes into account where the sensitive data resides.

There is therefore a need for a method and system for reporting entitlements, monitoring access, and setting access controls for files in big data stores, which takes into account where the sensitive data resides.

### BRIEF DESCRIPTION OF THE DRAWINGS

FIG. 1 is a block diagram of an example system for entitlement setting, mapping, and monitoring sensitive data in big data stores.

FIG. 2 is a flow diagram of an example method of monitoring and controlling access to sensitive data in a large distributed data store

### DETAILED DESCRIPTION OF THE INVENTION

Before describing in detail embodiments that are in accordance with the invention, it should be observed that the embodiments reside primarily in combinations of method steps and system components related to entitlement setting, mapping, monitoring and access-controlled decryption. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, or apparatus that comprises a list of elements does not include only those elements but may include other elements not expressly listed or inherent to such process, method, or apparatus. An element preceded by “comprises . . . a” does not, without more constraints, preclude the existence of additional identical elements in the process, method, or apparatus that comprises the element.

Various embodiments of the invention provide a method for securing sensitive data content in a highly distributed file system. Various embodiments of the invention also provide a system which provides the ability to map entitlement to entities such as files or tables containing sensitive content, to set access controls to these entities, and to monitor access to these entities.

An example system provides a report to an operator that overlays sensitive data information with who has access, and checks an access control list or an entitlement report for effectiveness. The access control list or entitlement report can be iterated for improvement based on the assessment of effectiveness. Then, the example system can overlay sensitive data information with who is actually accessing the sensitive data. This enables a user to intelligently monitor certain users or subsystems of the big data store.

In any file or data storage system, there are access controls that define which users have access and in what mode. This same methodology is prevalent in the case of big data stores. Existing techniques of viewing and setting access control do it as a stand-alone item, or add information about sensitive data that is collected in an ad hoc or manual fashion. The method described here depends on automatic determination of sensitive items and the entities that contain it within the data store. In this document, we refer to an entity such as a file or a table containing sensitive items as a “sensitive entity”. Once this information is collected, an entitlement report is presented to the security personnel. This entitlement report highlights the sensitive entities, and the access that various users of the big data store have to those sensitive entities. In an embodiment, if access control lists already exist, they can be compared against the access which users have to various sensitive entities, and can be modified or corrected based on the entitlement report. Alternatively, access control lists can be generated from the entitlement report.

In addition to showing sensitive entities, and who has access to those entities, the entitlement report also shows what remediation actions have been taken on the sensitive entities to protect them. For example, if the sensitive entity is quarantined or masked or encrypted, that can be indicated. If the original sensitive entity is retained, and a masked or encrypted entity is created that has protected the sensitive data, the two-way relationship between the original sensitive entity and the de-sensitized resultant entity can be shown in the entitlement report.

In addition to presenting a view of which users have access to the various entities in the big data store, with particular emphasis on sensitive entities, the method and system also provides for monitoring the activities of various users, with particular emphasis on the users' activities on sensitive entities.

The method and system disclosed herein provide a solution to interface with one or more of, but not limited to, the following, in order to gather the monitoring data on user access: the audit log of the big data store, the file access API exposed by the big data store, the underlying operating system on which the big data store runs, and the network that connects the big data store to the outside world. The monitoring data may be one or more of, but not limited to, user name, group the user belongs to, the IP address from which the user is accessing the big data store, the tool, such as browser or other application, through which the user is accessing the big data store, the specific entities that the user is accessing, and the time at which the access is being attempted.

The monitoring data thus gathered is overlaid with the information about the sensitive entities, in order to provide a picture of who is accessing or attempting to access the sensitive entities. Based on security policies of the organization, this information may then be used to prevent future access or cut off an ongoing access by a user. The system provides facilities for such control.

Further to the above, the data collected on entitlements and on user actions upon the sensitive and other data can be used to draw additional conclusions such as, but not limited to, peak periods of access, particularly popular or important sensitive entities, specific places of origin, and types of access.

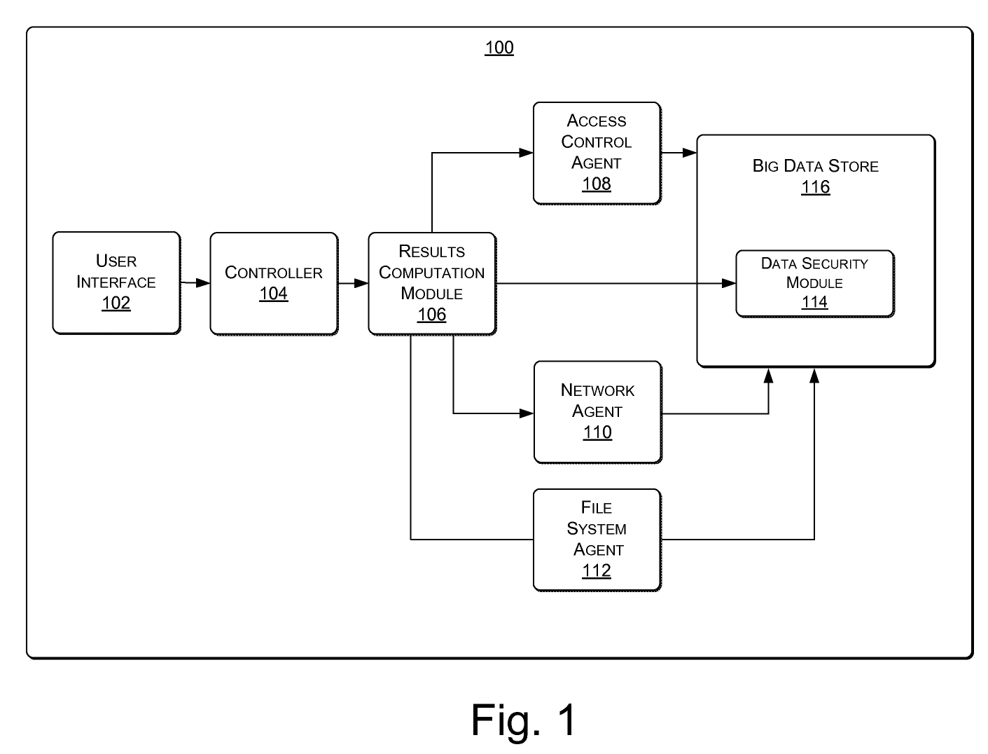

FIG. 1 shows an example system 100 for providing entitlement setting, mapping, and monitoring in big data stores. (Arrows represent a two-way data communication coupling.) There are other ways in which the system can also be configured. This is only exemplary of how such a system can be organized. The elements of FIG. 1 include a user interface 102, one or more controllers 104, one or more results computation modules 106, one or more access control agents 108, one or more network agents 110, one or more file system agents 112, and one or more data security modules associated with a big data store 116, such as a large distributed file system (DFS) 116.

At the user interface 102, a user initiates sensitive data discovery, masking, encryption, and access control actions. These are exemplary actions and others may also be initiated by the user interface 102. For example, the user interface 102 may be used to initiate blocking of a user from accessing any file in the big data store 116.

The controller 104 collects all the information from the plurality of agents (108 & 110 & 112), and maintains the information in a repository, for example, internal to the controller 104. The controller 104 also takes commands from the user interface 102 and passes them on to the appropriate agent or module downstream. The controller 104 also reports back data requested by the user interface module 102.

The results computation module 106 interfaces with the plurality of agents (108 & 110 & 112) and modules, and gathers information specific to a particular big data cluster 114. One or more results computation modules 106 may attend to different clusters, and may be attached to one controller 104.

The access control agent 108 sets access control privileges for users in the big data store 116. The access control agent 108 also reports accesses to various entities in the big data store 116 by users. The access control agent 108 also reports whether sensitive data is being accessed. The above tasks are exemplary, and the access control agent 108 may be responsible for a plurality of tasks related to access control in the big data store 116.

The network agent 110 observes a network for accesses to and from the big data store 116, and at least reports on what sensitive data is being accessed. In an embodiment, network agent 110 may communicate directly with the access control agent 108 to collate the information. In another embodiment, network agent 110 may send its information to the results computation module 106, which then does the collation. Other embodiments of the network agent 110 are also possible.

The file system agent 112 monitors the file system operational with the big data store 116, and detects creation, deletion, modification, and access of files, and collates them with user information as well as higher-level big data store entities such as documents in order to report on file activity. In an embodiment, the file system agent 112 may collaborate directly with the access control agent 108 and the network agent 110. In another embodiment, the file system agent 112 may send its data to the results computation module 106 for collation. Other embodiments of the file system agent 112 are also possible.

The data security module 114 runs inside the big data store 116 and does discovery, masking, encryption, and quarantining of sensitive data. In a scenario, there may be multiple instances of this module running in parallel. The one or more data security modules 114 report back to the results computation module 106 with results of their actions, which are then collated for reporting via the controller 104 to the user interface 102.

### EXAMPLE METHOD

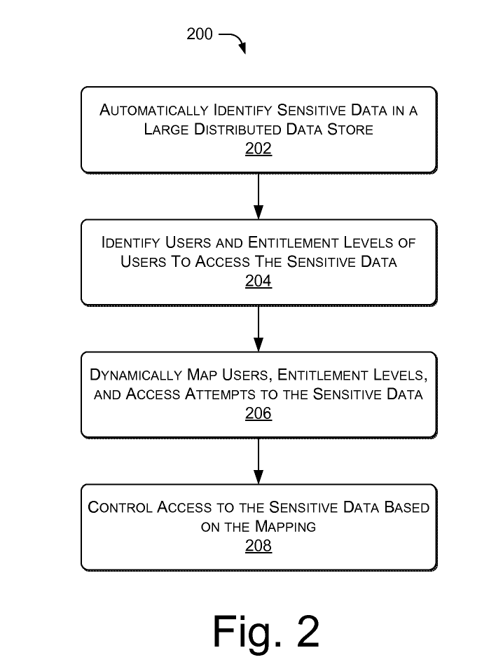

FIG. 2 shows an example method 200 of monitoring and controlling access to sensitive data in a large distributed data store. In the flow diagram, individual steps are shown as blocks. The example method 200 may be executed by computer hardware and software, such as system 100.

At block 202, sensitive data in a large distributed data store is automatically identified. A discovery technique operating as multiple instances of a data security module running in parallel may find and identify the sensitive data distributed over a big data store.

At block 204, users and their access entitlement levels are identified with respect to the sensitive data identified.

At block 206, users, their entitlement levels, and their attempts to access the sensitive data are mapped with respect to the sensitive data. The mapping may be displayed for a user as an entitlement report or an access control list. The mapping, report, or list may be iterated in real time and improved based on an ongoing assessment of its effectiveness.

At block 208, access to the sensitive data is controlled, based on the mapping. The access control can be under an operator's control, who has high enough privileges in the system. Access control may take many forms, such as not decrypting the sensitive data for requests that do not qualify. A user interface presents a dynamic visual display of sensitive data summary, for example the entities that contain the sensitive data, overlaid in real time with the current users and user entitlement levels for each part of the sensitive data. A visual display of access attempts by a given user, including current and historical attempts to access a given sensitive data entity can be viewed, and stored for analysis and modification of access control.

The various embodiments of the example system 100 and method 200 provide efficient techniques and a system for entitlement setting, mapping, monitoring and access-controlled decryption.

Those skilled in the art will realize that the above-recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as critical, or required.

1. A method, comprising:
identifying sensitive data in a large distributed file system (DFS) by applying an automatic search scaled through parallel processing to the DFS;
identifying one or more users having a level of entitlement to access the sensitive data;
mapping each user and each corresponding level of entitlement to the sensitive data; and
creating an entitlement report updated in real time of the sensitive data showing each user in relation to each level of entitlement to access a part of the sensitive data.

2. The method of claim 1, wherein the DFS comprises one of a HADOOP system, a distributed key-value store HBASE system, a NOSQL system, a COUCHBASE system, a MONGODB system, or a large distributed data store.

3. The method of claim 1, wherein the search for the sensitive data identifies an entity containing the sensitive data, wherein the entity comprises one of a file or a table.

4. The method of claim 1, wherein the entitlement report dynamically overlays the sensitive data with the users that have access to the sensitive data;
further comprising calculating an effectiveness of the entitlement report for identifying the sensitive information and overlaying the users; and
regenerating the entitlement report based on the effectiveness.

5. The method of claim 4, further comprising creating the entitlement report containing an overlay of the sensitive data with access attempts to the sensitive information to monitor a user or a subsystem of the large DFS.

6. The method of claim 1, further comprising generating a remediation process based on the entitlement report, wherein a remediation action is selected from the group consisting of quarantining sensitive data, encrypting sensitive data, masking sensitive data, and deleting sensitive data.

7. The method of claim 1, further comprising monitoring access of each user to the sensitive data based on the entitlement report to create monitoring data, by accessing one of an audit log of the DFS, a file access activity of a user, an application programming interface (API) exposed by the DFS, an operating system used at least in part by the DFS, and a network used at least in part by the DFS.

8. The method of claim 7, wherein the monitoring access to the sensitive data includes monitoring one of a user name, a group the user belongs to, an IP address from which the user accesses the DFS, a browser or other application through which the user accesses the DFS, a specific entity the user accesses, and a time at which the access is attempted.

9. The method of claim 1, further comprising setting an access control to prevent or allow a user to access the sensitive data; and
updating the entitlement report to include the access control.

10. The method of claim 9, further comprising preventing a current attempt to access the sensitive data by a user based on the entitlement report.

11. The method of claim 10, wherein the preventing a current attempt to access the sensitive data further comprises one of refusing to decrypt the sensitive data, refusing to unquarantine the sensitive data, refusing to unmask the sensitive data, controlling a plain reading of the sensitive data, or controlling a modification of the sensitive data.

12. A system, comprising;
a data security module including multiple instances running in parallel for controlling access to sensitive data in a large distributed data store;
an access control agent to set access control privileges for users to access the sensitive data in the large distributed data store;
a results computation module in communication with the large distributed data store and the access control agent to gather information specific to the large distributed data store;
a controller to collect information from the access control agent and maintain the information in a repository and to communicate with the access control agent; and
a user interface for enabling a user to communicate with the controller to initiate one of discovery of the sensitive data, masking of the sensitive data, encryption of the sensitive data, and access control of the sensitive data.

13. The system of claim 12, wherein the data security module performs discovery, masking, encryption, and quarantining of the sensitive data; and
wherein the data security module reports to the results computation module with results to be collated for reporting via the controller to the user interface.

14. The system of claim 12, further comprising a file system agent to monitor a file system of the large distributed data store and to detect a creation, a deletion, a modification, or an access of a file.

15. The system of claim 14, further comprising a network agent to observe a network for accesses to and from the large distributed data store.

16. The system of claim 15, wherein the results computation module is in communication with file system agent and the network agent and reports accesses to sensitive data in the large distributed data store to the controller.

17. The system of claim 16, wherein the access control agent is in communication with the file system agent and the network agent and reports when sensitive data is being accessed.

18. The system of claim 12, wherein the controller collates results from the results computation module for display by the user interface;
wherein the controller creates an entitlement report dynamically overlaying the sensitive data with the users that have access to the sensitive data; and
wherein the entitlement report contains an overlay of the sensitive data with access attempts to the sensitive information to monitor a user or a subsystem of the large distributed data store.

19. The system of claim 12, wherein the user interface further initiates blocking a user from accessing the sensitive data.

20. The system of claim 12, wherein multiple results computation modules are associated with respective big data clusters and are in communication with the controller.
